(19) United States
(12) Patent Application Publication
(10) Pub. No.: US 2016/0103561 A1
(43) Pub. Date: Apr. 14, 2016

(54) IDENTIFYING PRODUCTIVE THUMBNAILS FOR MEDIA CONTENT

(71) Applicant: Google Inc., Mountain View, CA (US)

(72) Inventor: Juhyun Lee, San Jose, CA (US)

(73) Assignee: Google Inc., Mountain View, CA (US)

(21) Appl. No.: 13/969,006

(22) Filed: Aug. 16, 2013

(51) Int. Cl. G06F 3/0482

(52) U.S. Cl. CPC G06F 3/0482

(57) ABSTRACT

References to videos or other media content are often accompanied by a thumbnail that is in some way representative of the video. Selection of this thumbnail can have a significant impact on the productivity of the reference, e.g., in driving traffic to the underlying video or other media content. Accordingly, the performance of various candidate thumbnails can be monitored and the thumbnail that performs best can be selected as the primary thumbnail, which can be presented most often in connection with references to the video or other media content.

### TECHNICAL FIELD

This disclosure generally relates to determining a performance metric for a thumbnail that is presented in connection with a reference to media content and/or automatically selecting a primary thumbnail to be presented for the media content based on the performance metric.

### BACKGROUND

Media content is often advertised to an end user using a thumbnail. For example, consider a video (or other media content) hosting site or service that lists the videos that are available from the hosting site or service. Typically, each video is associated with a thumbnail that accompanies a link or other reference to the video. Clicking on the thumbnail or other portion of the reference results in a presentation of the video.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to selecting a thumbnail determined or predicted to provide superior performance. An identification component can be configured to identify a set of thumbnails associated with an item of media content. A thumbnail from the set of thumbnail is to be presented in connection with a reference to the media content. Hence, when a content consumer sees a reference to the media content such can be accompanied by the thumbnail. An analysis component can be configured to respectively determine a performance metric associated with multiple thumbnails from the set that have been presented. A selection component can be configured to select from the set of thumbnails a primary thumbnail that is determined or predicted to have a best performance metric.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a block diagram of an example system that can monitor the performance of thumbnails for an item of media content and select or update a primary thumbnail for the media content with a thumbnail that demonstrates exemplary performance in accordance with certain embodiments of this disclosure;

FIG. 2A illustrates a block diagram of various examples of media content in accordance with certain embodiments of this disclosure;

FIG. 2B illustrates a block diagram of various examples of thumbnails that might be associated with the various types of media content in accordance with certain embodiments of this disclosure;

FIG. 3 illustrates a block diagram of various examples of the performance metric in accordance with certain embodiments of this disclosure;

FIG. 4 illustrates a block diagram of an example system that can provide for additional aspects or features in connection with monitoring the performance of thumbnails for an item of media content in accordance with certain embodiments of this disclosure;

FIG. 5 illustrates a block diagram that depicts various non-limiting examples of additional input in accordance with certain embodiments of this disclosure;

FIG. 6 illustrates an example methodology that can provide for selecting a primary thumbnail for the media content with a thumbnail that demonstrates superior performance in accordance with certain embodiments of this disclosure;

FIG. 7 illustrates an example methodology that can provide for additional features or aspects in connection with selecting a primary thumbnail for the media content in accordance with certain embodiments of this disclosure;

FIG. 8 illustrates an example schematic block diagram for a computing environment in accordance with certain embodiments of this disclosure; and

FIG. 9 illustrates an example block diagram of a computer operable to execute certain embodiments of this disclosure.

### DETAILED DESCRIPTION

### Overview

When considering a media content hosting site or service, available media content is often listed using a thumbnail associated with the media content. For example, a user can visit the hosting site (or an intermediary) and perform a search of the available media content. Results of the search can return a listing of available media content matching the search criteria and these results are typically accompanied by a thumbnail representing the respective media content result. As another example, an ad can be presented that includes a link or reference to an item of media content. Similarly, the ad can be accompanied by a thumbnail that is representative of the media content.

In many cases, the thumbnail is selected from among the contents of the associated item of media content. For example, if the media content is a video, then the thumbnail is generally a particular frame of the video. If the media content is audio content (e.g., a song or audio transcript, etc.), the thumbnail can be a specific sampling portion (e.g., 20 seconds) of the audio content. If the media content relates to illustrations of a book or graphic novel, then the thumbnail can be a particular image included in the set of illustrations, and so on. In addition, the thumbnail can also relate to an icon presented on a user interface, such as an icon for an application, document, or the like.

However, regardless of whether the thumbnail draws from the media content itself or is independent of the media content (e.g., other content), the thumbnail is generally in some way representative of the media content. Research indicates that selection of the thumbnail to be presented in connection with a reference to an associated item of media content can have a significant impact on directing traffic to the associated item of media content. Thus, improving or optimizing thumbnail selection can be beneficial to content owners, content consumers, content hosting sites or services, and others. In addition, thumbnail selection can be provided in an automated fashion that can reduce the burden on content owners and the risk of unnecessary error or missed opportunities. For example, techniques disclosed herein can be employed to prevent poor thumbnail performance. In cases where a primary thumbnail consistently performs worse than other tested thumbnails, the original thumbnail can be replaced. Thumbnail selection can also be provided in a manner that evolves over time such as responding to newly detected trends or characteristics associated with a potential content consumer, which can further improve convenience and success.

By way of illustration, consider a video content hosting site or service in which a user (e.g., content owner, curator, etc.) uploads a video for access by content consumers. Initially, the user might select a representative thumbnail or set of thumbnails or such might be determined in another manner, including based on techniques disclosed herein. Suppose two candidate thumbnails are selected, but as yet it is not adequately known which of the two thumbnails will be more successful in attracting content consumers to the video. In some embodiments, both thumbnails can be exposed in connection with various references to the video.

For example, half (or another percentage) of all references to the video can include the first candidate thumbnail and the other half (or another percentage) can include the second candidate thumbnail. Over time, if no statistically significant distinction is revealed between the performance of the first candidate thumbnail and the second, then thumbnails associated with references to the video can be continued as-is, or can converge on either one of the candidate thumbnails. On the other hand, if the first candidate thumbnail performs statistically significantly more effectively than the second candidate thumbnail, then the first candidate thumbnail can be selected as the primary thumbnail. Typically, the primary thumbnail will be used with a substantial portion of links or references to the video. However, some references, typically a small fraction, can continue to include the second candidate thumbnail or even other candidate thumbnails, which can be employed to monitor the continuing performance of the candidate thumbnails as well as the primary thumbnail.

Such can be further generalized to N candidate thumbnails, where N can be substantially any positive integer. For example, suppose N=6, where the first candidate thumbnail is believed to be the most effective. In that case, the first candidate thumbnail can be assigned to, e.g., 95% of the references to the video that are presented (e.g., as results to a search, etc.). The remaining five candidate thumbnails can each be assigned to 1% (or another percentage) of the references to the video. Further suppose that it is detected that the third candidate thumbnail tends to generate, e.g., 20% more clicks (or other metric related to thumbnail performance) than all other thumbnails. In that case, the third candidate thumbnail can replace the first candidate thumbnail as the primary thumbnail, and therefore be used in connection with 95% of the references to the video, with the remaining 5% continuing to test performance for other candidates.

In some embodiments, additional information can be employed in the selection of a thumbnail to display in connection with a reference to the video. For example, if available and consensual, information associated with the content consumer's device can be employed to tailor the thumbnail in a manner that is predicted or determined to result in improved performance. For instance, the IP address or another geo-location technique can be employed to identify an approximate location of a content consumer. Thus, the thumbnail served in connection with a reference to the video can differ between a first content consumer and a second content consumer due to the respective location determinations. Such can leverage regional differences between content consumers by selecting thumbnails determined to appeal to content consumers based on regional identity. Numerous other examples exist, such as contextual location (e.g., home vs. work), time-of-day, genre, trend data, preferences or settings, and so forth, which is further detailed herein. Such tailoring can even be specific to an individual device (or user), typically only limited by the relevant data that can be obtained and/or consented to.

### Example Thumbnail Selection

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

It is to be appreciated that in accordance with one or more implementations described in this disclosure, users can opt-out of providing personal information, demographic information, location information, proprietary information, sensitive information, machine information, or the like in connection with data gathering aspects. Moreover, one or more implementations described herein can provide for anonymizing collected, received, or transmitted data.

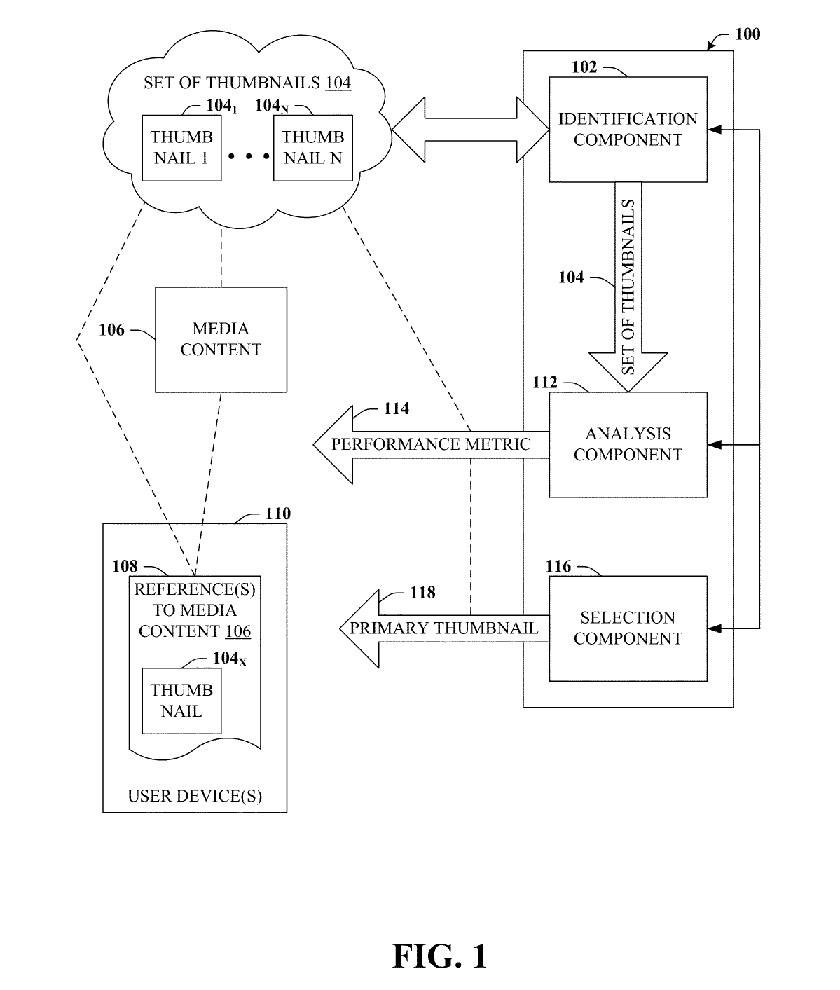

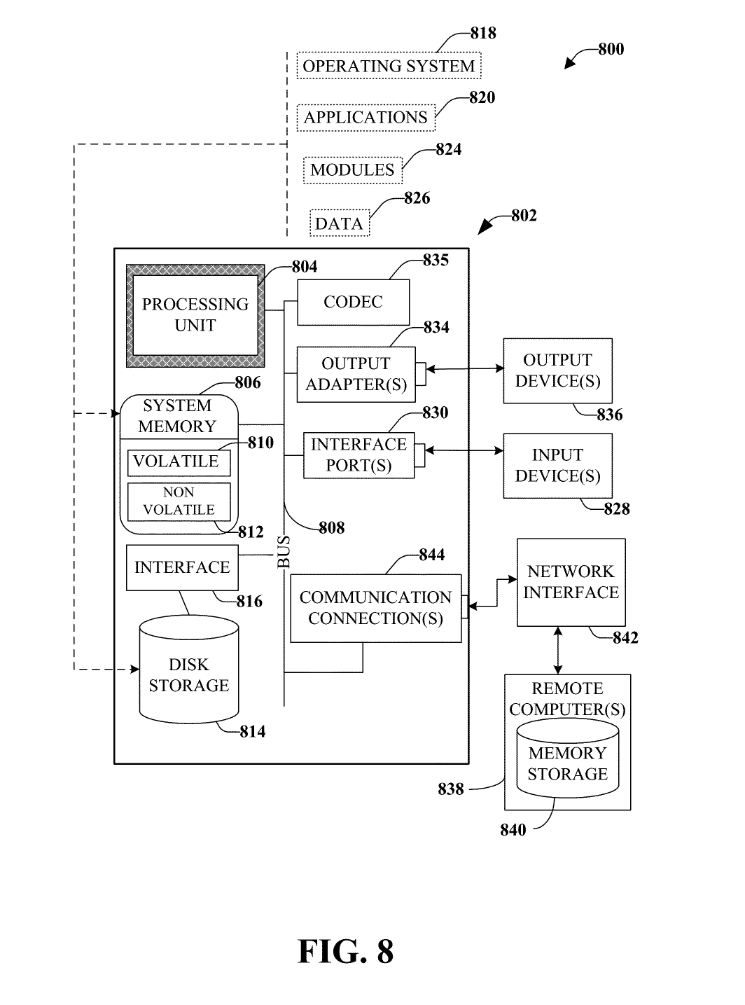

Referring now to FIG. 1, a system 100 is depicted. System 100 can, inter alia, monitor the performance of thumbnails for an item of media content and select or update a primary thumbnail for the media content with a thumbnail that demonstrates exemplary performance. Embodiments disclosed herein can, for example, drive additional traffic to the media content; automate both initial and on-going thumbnail selection, which can provide added value to users and reduce the likelihood of choosing a thumbnail that results in poor performance. System 100 can include a memory that stores computer executable components and a processor that executes computer executable components stored in the memory, examples of which can be found with reference to FIG. 8. It is to be appreciated that the computer 802 can be used in connection with implementing one or more of the systems or components shown and described in connection with FIG. 1 and other figures disclosed herein. As depicted, system 100 can include an identification component 102, an analysis component 112, and a selection component 116.

Identification component 102 can be configured to identify set of thumbnails 104 associated with media content 106. Set of thumbnails 104 can include substantially any number, N, of individual thumbnails 104₁-104_{N}, which are hereinafter referred to, either individually or collectively, as thumbnail(s) 104, with appropriate subscripts generally employed only when instructive or convenient to highlight various distinctions or to better impart the disclosed concepts. A given thumbnail 104 can be presented in connection with a reference 108 to media content 106. Reference 108 can include a link or embedded element that accesses media content 106, or any other suitable mechanism that can be presented by user device 110. For example, reference(s) 108 can be provided as results to a search directed to media content 106 or similar items, an ad for media content 106, a purchase transaction interface, and so forth.

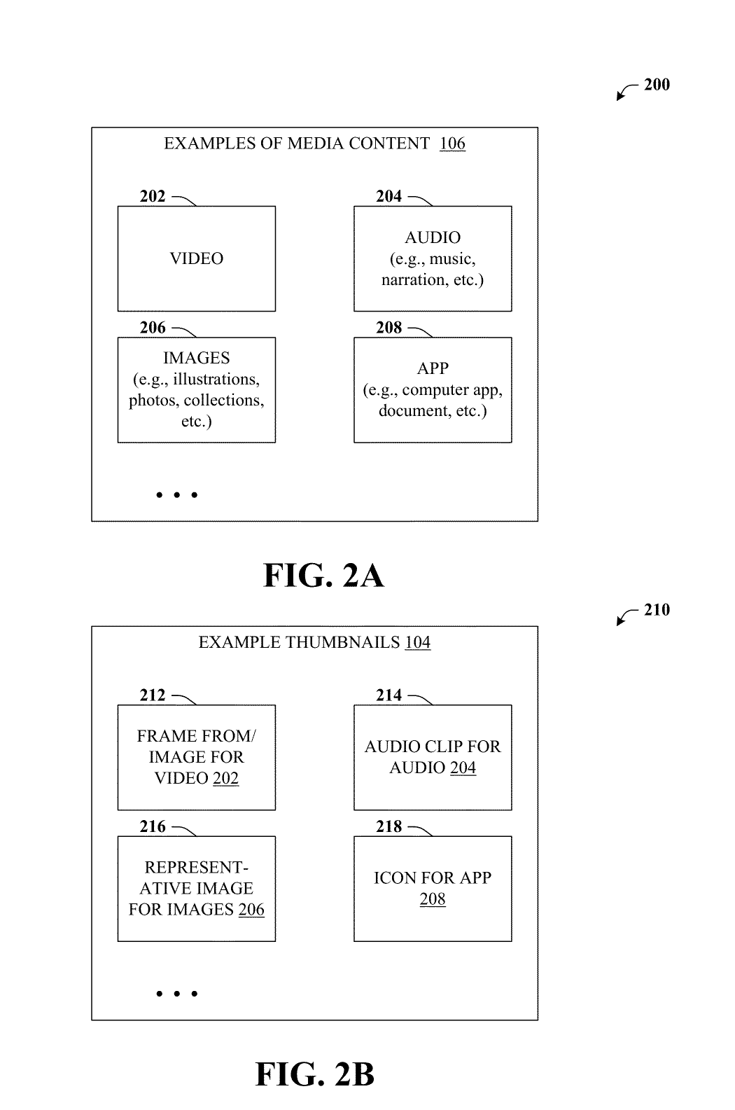

While still referring to FIG. 1, but turning also to FIGS. 2A and 2B, illustrations 200 and 210 are provided. Illustration 200 depicts various examples of media content 106 and illustration 210 provides examples of thumbnails 104 that might be associated with the various types of media content 106. For example, media content 106 can be a video 202 in which case an associated thumbnail 104 might be a frame from or an image 212 that is representative of video 202. Typically, image 212 will be a frame extracted from or included in video 202, but such is not required.

As another example, media content 106 can be an audio 204 such as, e.g., a song or other musical composition, a narration of a book or another literary work, or the like. In such cases, the associated thumbnail 104 can be audio clip 214. In some embodiments, audio clip 214 can be a portion of audio 204. Hence, just as selecting the right image 212 to serve as thumbnail 104 for video 202 can lead to improved performance, selecting the right portion of audio 204 or another audio clip 214 for audio 204 can also result in improved performance. For instance, consider a first thumbnail 104 that provides a 25 second sample of the first chorus of a song versus a second thumbnail 104 that provides a 30 second sample of the second chorus of the song.

As a third example, media content 106 can be images 206 such as, for example, illustrations or plates for a book, photographs, or various other collections. References 108 to media content 206 of this type or related types can also include thumbnail 104, which can be representative image 216. Generally, representative image 216 can be selected from among images 206, but such is not necessarily required. For instance, image 216 might relate to an artist, photographer, painter, or editor of the underlying media content 106. As another example, media content 106 can be computer-based applications or apps 208 or documents or other files that are invoked by the app 208. In that case, thumbnail 104 can be an icon 218 associated with app 208. Other examples of media content 106 can exist, and corresponding thumbnails 104, unique to that type of media content 106 or otherwise, can also exist. Therefore, examples provided herein are not intended to be limiting. Rather, media content 106 can include substantially any type of content that can be accessed by way of reference 108. Likewise, thumbnail 104 can be substantially any type of presentation that can be included in reference 108, typically one that is representative of media content 104.

Still referring to FIG. 1, analysis component 112 can be configured to respectively determine performance metric 114 associated with multiple thumbnails from set of thumbnails 104 that have been presented. Hence, each of the multiple thumbnails 104 can be assigned an associated performance metric 114, which can be determined by monitoring the performance tied to each of the multiple thumbnails 104. Analysis component 112 can determine these performance metrics 114 in a statistical or empirical manner by monitoring various transactions associated with media content 106 and/or thumbnail(s) 104 or reference(s) 108.

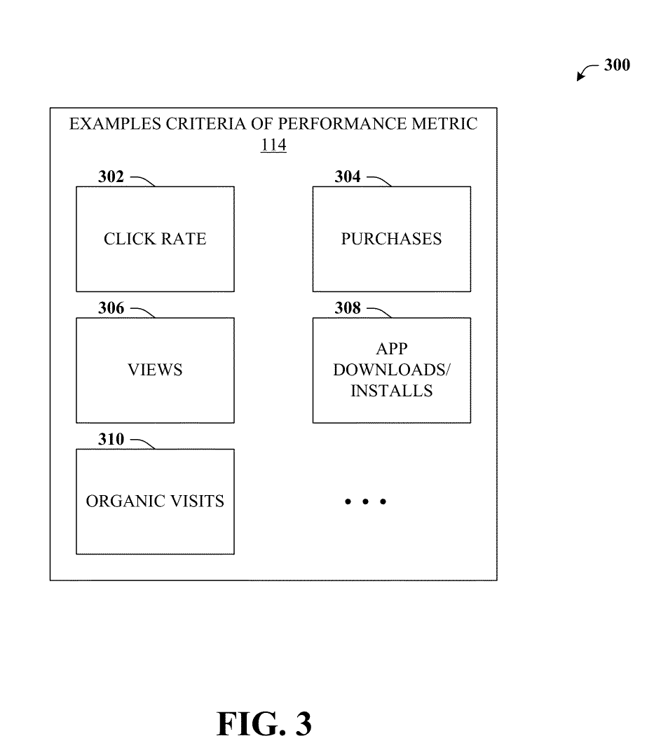

Selection component 116 can be configured to select from the set of thumbnails 104 a primary thumbnail 118 that is determined to have a best performance metric 114. Primary thumbnail 118 can be associated with media content 106 in such a way that primary thumbnail 118 can be the default thumbnail that is presented in connection to references 108 to media content 106. Primary thumbnail 118 can be presented along with a significant portion of references 108 in order to leverage the superior performance analysis component 112 revealed in terms of performance metric 114, examples of which are provided with reference to FIG. 3.

While still referring to FIG. 1, but turning as well to FIG. 3, illustration 300 depicts various examples of performance metric 114. For example, performance metric 114 can relate to a click rate 302 such as a number or ratio of clicks on reference 108 to access media content 106 that occur in connection with a particular thumbnail 104 included in reference 108. Performance metric 114 can relate to a number or ratio of purchases 304 of media content 106 in connection with a particular thumbnail 104. Performance metric 114 can also relate to a number or ratio of views of the media content 106 that result when a particular thumbnail 104 is presented in reference 108 to media content 106.

As another example, performance metric 114 can relate to app (e.g., app 208) downloads or installs 308, which can be determined based on a ratio of the number of times app 208 is downloaded and/or installed versus a number of times an associated icon 218 or other thumbnail 104 is presented. Performance metric 114 can also be function of organic visits 310, which can distinguish between a user selecting reference 108 a first time in which no action is taken (e.g., purchase 204, download/install 308), but for which action is taken on a subsequent visit.

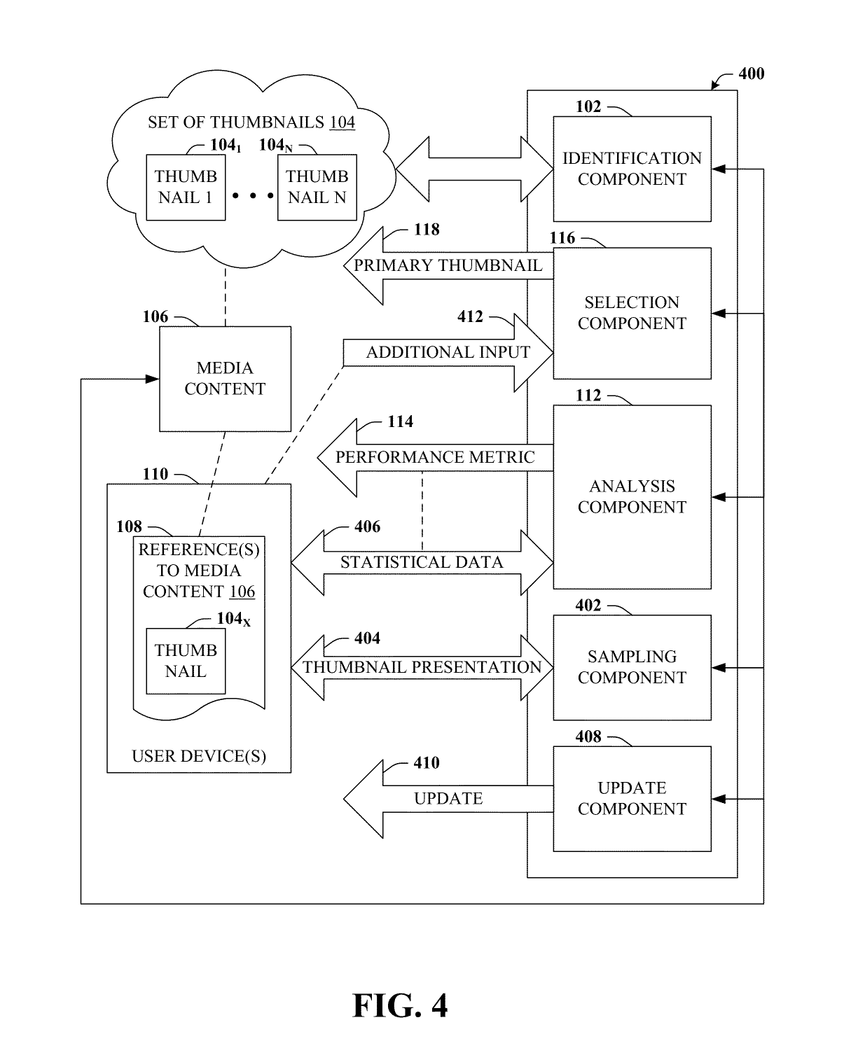

Turning now to FIG. 4, system 400 is provided. System 400 can provide for additional aspects or features in connection with monitoring the performance of thumbnails for an item of media content 106. System 400 can include identification component 102, analysis component 112, and selection component 116 as substantially described supra in connection with FIG. 1 and herein. In addition, system 400 can include sampling component 402 and update component 408.

Sampling component 402 can be configured to facilitate presentation 404 of multiple thumbnails 104 in connection with reference 108 to media content 106. For example, sampling component 402 can facilitate presentation 404 of a first candidate thumbnail 104 in connection with a first reference 108 to media content 106 and presentation 404 of a second candidate thumbnail 104 in connection with a second reference 108 to media content 106. Sampling component 402 can manage the distribution of both candidate thumbnails, e.g., equal distribution for all references 108 to media content 106 (e.g., the first thumbnail 104 assigned to 50% of references 108 and the second thumbnail 104 assigned to the other half). As another example, the first thumbnail 104 might currently be deemed primary thumbnail 118 or otherwise believed to be more productive and therefore be assigned to the bulk of references 108, e.g., 99% of references 108, with the second thumbnail 104 assigned to the remaining 1% of references 108. Such allocation of one or more thumbnails 104 to a particular percentage, proportion, or number of references 108 can be determined according to a policy associated with the content hosting site or service or another authorized entity, such as the content owner.

The click rate, purchases, views, or other metric that is tied to a particular thumbnail 104 and/or the associated references 108 in which that particular thumbnail 104 was presented, can be received as statistical data 406 by analysis component 112. Analysis component 112 can determine performance metric 114 from such statistical data 406. Once performance metrics 114 for all or a portion of thumbnails 104 are determined, selection component 116 can determine primary thumbnail 118, generally as the thumbnail 104 that results in a superior performance metric 114. Because primary thumbnail 118 is generally one that has superior performance, primary thumbnail 118 can be assigned to be associated with presentation 404 for a significant proportion of references 108. Such can be accomplished by update component 408.

For example, update component 408 can be configured to update 410 a default thumbnail 104 associated with media content 106 with primary thumbnail 118 in connection with a portion of references 108 to media content 106. As one result, the primary thumbnail 118 will generally appear in a much larger percentage of references 108 relative to other thumbnails 104. Hence, the benefits provided by the superior performance of the primary thumbnail 118 can be realized, while testing and analysis on a small set of references 108 can continue.

By way of illustration, consider the following scenario in which a non-limiting concrete example of the disclosed subject matter is provided. A content owner uploads a video (e.g., media content 106) to a video hosting site or service. During the upload process, the content owner selects a default thumbnail (e.g., primary thumbnail 118) that is to accompany certain references (e.g., reference 108) to the content owner's video. In some embodiments, the content owner can select several thumbnails (e.g., thumbnails 104) that can be vetted to determine which is most productive. In some embodiments, one or more thumbnail can be selected without input from the content owner, for example, based on analysis relating to thumbnail 104 selection for media content 106, trend data associated with thumbnails 104 or performance metrics 114, analysis of media content 106, or even randomly selected from among the contents of media content 106 or from a media repository.

Suppose that after the upload process, four candidate thumbnails have been identified, but no preferential weight is given to any of the four. In that case, each of the four candidate thumbnails might be assigned to an equal percentage of references to the video (e.g., each candidate thumbnail appears in approximately 25% of the references to the video). Alternatively, it might be determined, either by the content owner or systems or components detailed herein that one of the four is preferred and/or predicted or determined to yield better performance. In that case, the preferred thumbnail might be initially allocated for most of the references, e.g., 70% (since it is indicated or predicted to perform better), while each of the other three can be allocated to smaller proportions of the references, e.g., 10% each.

Over time, content consumers will be exposed to references to the video (e.g., sampling component 402 can facilitate thumbnail presentation 404 on a user interface of user device 110), for example, when such references 108 are presented based on search results, advertisements, promotions, or other web behavior. When exposed, the content consumer might click on the reference 108 in order to access the content owner's video, or might not. Analysis component 112 can determine which of the thumbnails 104 was presented with the reference 108 and whether or not such resulted in a click-through (or other behavior relating to performance metric 114). Once at least some minimum amount of data is known (e.g., via statistical data 406), analysis component 112 can construct performance metric 114 for each of the candidate thumbnails. Selection component 116 can designate the best performing candidate thumbnail 104 as primary thumbnail 118, which can be allocated for all references 108 to media content 106, possibly excluding a small fraction of references 108 that can be used to present other thumbnails 104 for on-going comparison or analysis.

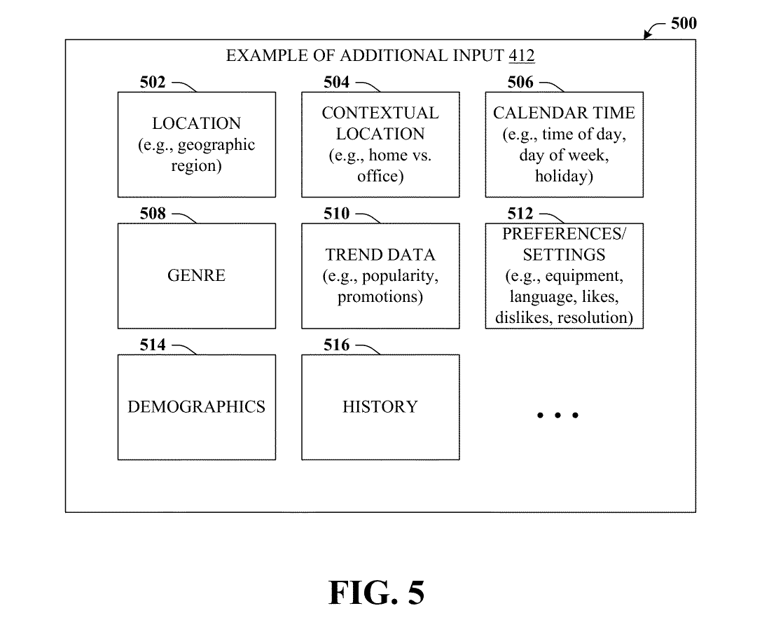

In some embodiments, identification component 102 can be configured to periodically reevaluate set of thumbnails 104 and identify a new set of thumbnails (not shown) that differs from set of thumbnails 104. Thereafter, analysis component 112 can, respectively, determine performance metric 114 for thumbnails in the new set of thumbnails, e.g., based on statistical data 406 that result from thumbnail presentations 404. Based on such analysis, selection component 116 can select primary thumbnail 118 from among the new set of thumbnails and update 410 can be applied such that a significant percentage of references 108 to media content 106 will present the primary thumbnail 118. In some embodiments, selection component 116 can select primary thumbnail 118 further based on information associated with user devices 110 that present references 108. Such information is denoted additional input 412 and further detailed in connection with FIG. 5.

With reference now to FIG. 5, illustration 500 is provided that depicts various non-limiting examples of additional input 412. For instance, additional input 412 can relate to location 502 such as a particular geographic region. To provide a concrete example of how location 502 might be used, consider the following. LeBron James is a very popular athlete who left a sports team in Ohio to join a sports team in Florida. As a result, James' popularity is greater in Florida than many other places, and is less popular in Ohio than many other places. Consider a video of a basketball program in which a still image of LeBron James jumping to dunk the basketball is selected as primary thumbnail 118. Consider further that a content consumer in which a reference 108 to the video is presented lives in Ohio, as determined by location 502, where James is generally less popular. Based on such additional information 412, primary thumbnail 118 for that particular presentation of reference 108 might be altered by selection component 116 or sampling component 402 to select and/or present a thumbnail 104 deemed to be more productive in Ohio.

In some embodiments, additional input 412 can relate to contextual location 504. For example, selection and/or presentation of a thumbnail 104 in a particular reference 108 can be modified based upon whether the content consumer (or by proxy user device 110) is at home versus at work, as such contextual location 504 can have a significant impact on what a content consumer finds appealing. Other examples of additional input 412 can include, e.g., calendar time 506 such as a time of day, day of the week, holiday, and so forth; genre 508 or other category relating to the underlying media content 106 (e.g., comedy, news, entertainment, etc.); or trend data 510 such as rising or declining popularity, memes, or the like, promotions or other scheduled events.

Another example of additional input 412 can be preferences/settings 512, which can relate to device 110. Such can relate to language, likes, dislikes, or associated equipment or features. For instance, device type or screen resolution can determine whether certain thumbnails 104 are available or might be used to determine whether a high-resolution thumbnail 104 should be selected or a low-resolution thumbnail 104. Demographics 514 relating to user device 110, the content owner, the content consumer, or another relevant entity can serve as another example of additional input 412. Further, another example of additional input 412 can be history 516. History 516 can relate to a browser history or a particular (e.g., current) session history or the like. For example, in cases where a content consumer is presenting content that is determined to be adult content, then adult-themed thumbnail 104 might be preferred. In contrast, the same user or a different user that has a history 516 of presenting content rated for children might result in a determination that adult-themed thumbnail 104 is not appropriate and therefore should not be selected for presentation. It is understood that other suitable examples of additional input 412 can exist, and can include any suitable data or information that can have an impact on what a content consumer might find appealing or interesting. It is further understood that all such additional input 412 can be collected based on user authorization and/or consent.

### Example Methods for Thumbnail Selection

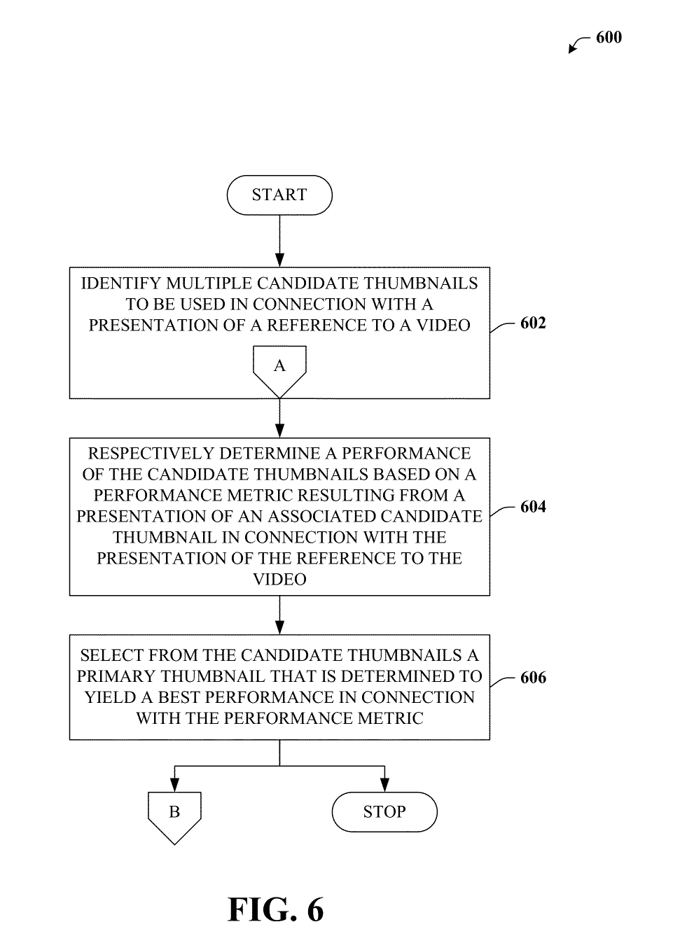

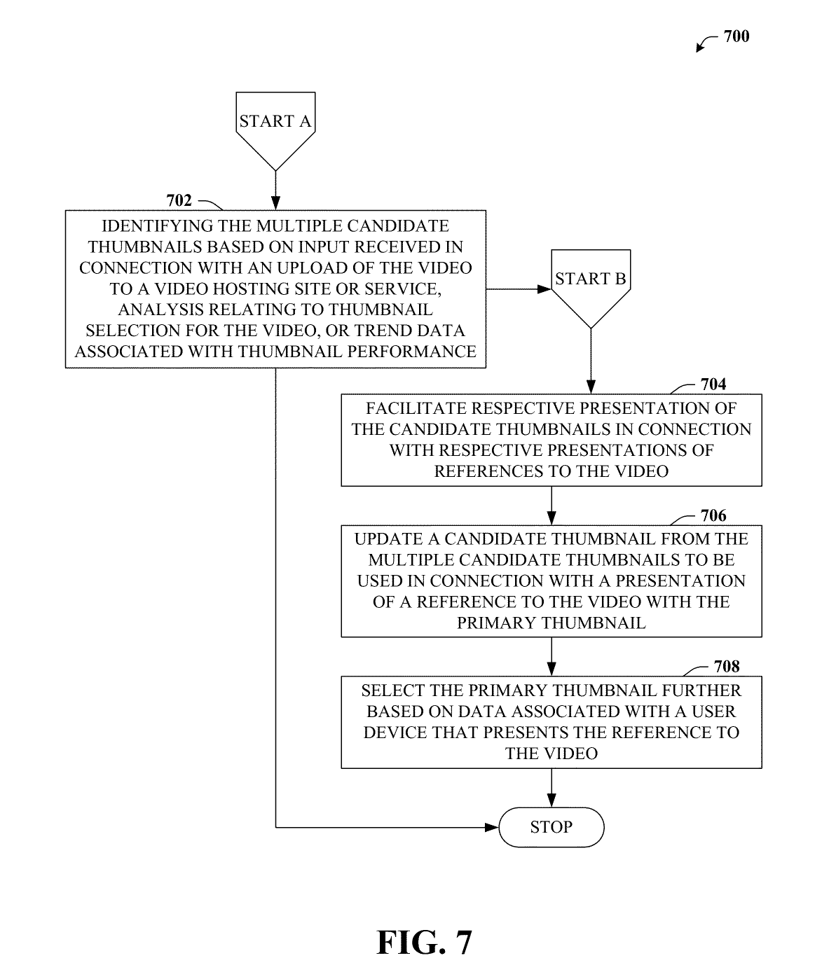

FIGS. 6 and 7 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 6 illustrates exemplary method 600. Method 600 can provide for selecting a primary thumbnail for the media content with a thumbnail that demonstrates superior performance. For example, at reference numeral 602, multiple candidate thumbnails to be used in connection with a presentation of a reference to a video (or other media content) can be identified (e.g., by an identification component). Method 600 can proceed to insert A, discussed in connection with FIG. 7 or to reference numeral 604.

At reference numeral 604, a performance of the multiple candidate thumbnails can be respectively determined (e.g., by an analysis component). The respective performances can be determined based on a performance metric resulting from a presentation of an associated candidate thumbnail in connection with the presentation of the reference to the video.

At reference numeral 606, a primary thumbnail can be selected from among the multiple candidate thumbnails (e.g., by a selection component). The primary thumbnail can be selected in response to a determination that the selected candidate thumbnail yields a best performance in connection with the performance metric. The performance metric can be related to, for instance, clicks, views, purchases, or another metric in connection with the reference in which the associated candidate thumbnail is presented. Method 600 proceeds to insert B detailed in connection with FIG. 7 or ends.

Turning now to FIG. 7, exemplary method 700 is depicted. Method 700 can provide for additional features or aspects in connection with selecting a primary thumbnail for the media content. Method 700 can begin at the start of insert A or the start of insert B. At reference numeral 702, the multiple candidate thumbnails identified at reference numeral 602 of FIG. 6 can be identified further based on input received in connection with an upload of the video to a video hosting site or service, analysis relating to thumbnail selection for the video, trend data associated with thumbnail performance, or another suitable means. Method 700 can end or proceed to the start of insert B.

At reference numeral 704 presentations of the candidate thumbnails can be respectively facilitated (e.g., by a sampling component). Such presentations can be provided in connection with respective presentations of various references to the video. For example, references to the video can be presented in connection with a search for related content, as an ad placement, a promotion and so forth. When these references are presented (e.g., by a device of a content consumer), the references can be accompanied by one of the candidate thumbnails.

At reference numeral 706, a candidate thumbnail from the multiple candidate thumbnails to be used in connection with a presentation of a reference to the video can be updated with the primary thumbnail (e.g., by an update component). Hence, the primary thumbnail, which is typically determined to be the most productive at least in terms of a particular performance metric, can be represented more often with the various references to the video.

At reference numeral 708, the primary thumbnail (or another thumbnail that is to be presented in connection with a particular reference to the video) can be selected further based on data associated with a user device that presents the reference to the video. For example, the primary thumbnail (or another thumbnail to be presented) can be tailored to the content consumer in order to increase the potential performance of the thumbnail that is presented. Such tailoring can be based on the data, which can relate to, e.g., location, contextual location, calendar time, genre, trend data, preferences or settings, demographics, or other suitable data. Method 700 ends.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 8, a suitable environment 800 for implementing various aspects of the claimed subject matter includes a computer 802. The computer 802 includes a processing unit 804, a system memory 806, a codec 835, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI) or others now in existence or later developed.

The system memory 806 includes volatile memory 810 and non-volatile memory 812. The basic input/output system (BIOS), containing the basic routines to transfer information between elements within the computer 802, such as during start-up, is stored in non-volatile memory 812. In addition, according to present innovations, codec 835 may include at least one of an encoder or decoder, wherein the at least one of an encoder or decoder may consist of hardware, software, or a combination of hardware and software. Although, codec 835 is depicted as a separate component, codec 835 may be contained within non-volatile memory 812 or included in other components detailed herein such as compilation component 126. By way of illustration, and not limitation, non-volatile memory 812 can include read only memory (ROM), programmable ROM (PROM), electrically programmable ROM (EPROM), electrically erasable programmable ROM (EEPROM), or flash memory. Volatile memory 810 includes random access memory (RAM), which acts as external cache memory. According to present aspects, the volatile memory may store the write operation retry logic (not shown in FIG. 8) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), resistive RAM (RRAM), or others now in existence or later developed.

Computer 802 may also include removable/non-removable, volatile/non-volatile computer storage medium. FIG. 8 illustrates, for example, disk storage 814. Disk storage 814 includes, but is not limited to, devices like a magnetic disk drive, solid state disk (SSD) floppy disk drive, tape drive, flash memory card, or memory stick. In addition, disk storage 814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used, such as interface 816. It is appreciated that storage devices 814 can store information related to a user. Such information might be stored at or provided to a server or to an application running on a user device. In one embodiment, the user can be notified (e.g., by way of output device(s) 836) of the types of information that are stored to disk storage 814 and/or transmitted to the server or application. The user can be provided the opportunity to opt-in or opt-out of having such information collected and/or shared with the server or application (e.g., by way of input from input device(s) 828).

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802. Applications 820 take advantage of the management of resources by operating system 818 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, stylus, touch pad, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s) 828. Thus, for example, a USB port may be used to provide input to computer 802 and to output information from computer 802 to an output device 836. Output adapter 834 is provided to illustrate that there are some output devices 836 like monitors, speakers, and printers, among other output devices 836, which require special adapters. The output adapters 834 include, by way of illustration and not limitation, video and sound cards that provide a means of connection between the output device 836 and the system bus 808. It should be noted that other devices and/or systems of devices provide both input and output capabilities such as remote computer(s) 838.

Computer 802 can operate in a networked environment using logical connections to one or more remote computers, such as remote computer(s) 838. The remote computer(s) 838 can be a personal computer, a server, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

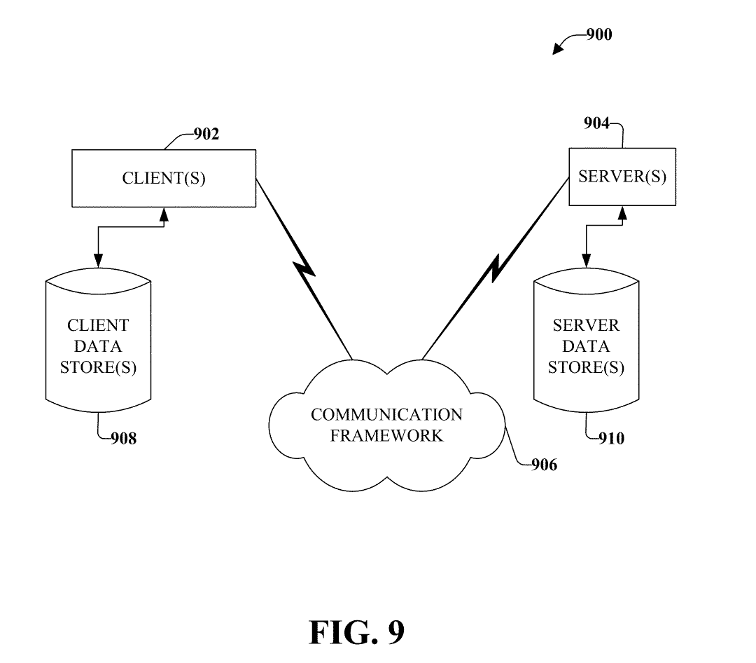

Referring now to FIG. 9, there is illustrated a schematic block diagram of a computing environment 900 in accordance with this specification. The system 900 includes one or more client(s) 902 (e.g., laptops, smart phones, PDAs, media players, computers, portable electronic devices, tablets, and the like). The client(s) 902 can be hardware and/or software (e.g., threads, processes, computing devices). The system 900 also includes one or more server(s) 904. The server(s) 904 can also be hardware or hardware in combination with software (e.g., threads, processes, computing devices). The servers 904 can house threads to perform transformations by employing aspects of this disclosure, for example. One possible communication between a client 902 and a server 904 can be in the form of a data packet transmitted between two or more computer processes wherein the data packet may include video data. The data packet can include a cookie and/or associated contextual information, for example. The system 900 includes a communication framework 906 (e.g., a global communication network such as the Internet, or mobile network(s)) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 and server 904 can compress the file in accordance with the disclosed subject matter. Likewise, server 904 can encode video information and transmit the information via communication framework 906 to one or more clients 902.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system, comprising:
a memory that stores computer executable components; and
a microprocessor that executes the following computer executable components stored in the memory:
an identification component that selects a set of thumbnails associated with a media content based upon a context of presentation of the media content, wherein a thumbnail from the set of thumbnails is to be presented in connection with a reference to the media content;
an analysis component that respectively determines a performance metric associated with multiple thumbnails from the set of thumbnails that have been presented; and
a selection component that selects from the set of thumbnails a primary thumbnail that is determined to have a best performance metric.

2. The system of claim 1, wherein the media content includes a video and the thumbnail includes an image to be presented in connection with the reference; the media content includes an audio and the thumbnail includes a portion of the audio; or the media content is a set of images and the thumbnail includes a representative image from the set of images.

3. The system of claim 1, wherein the identification component selects the set of thumbnails based on input received in connection with an upload of the media content to a content hosting site or service, analysis relating to thumbnail selection for the media content, or trend data associated with the performance metric.

4. The system of claim 1, wherein the performance metric is a function of a click rate that is a ratio of a number of requests to present the media content in response to a presentation of the thumbnail compared to a number of times the thumbnail was presented.

5. The system of claim 1, wherein the performance metric is a function of a number of purchase transactions relating to the media content, or a number of views or a number of presentation transactions relating to the media content.

6. The system of claim 1, further comprising a sampling component that respectively facilitates presentation of the multiple thumbnails from the set of thumbnails in connection with the reference to the media content.

7. The system of claim 6, wherein the sampling component facilitates presentation of a first thumbnail from the set of thumbnails in connection with a first portion of references to the media content and a second thumbnail from the set of thumbnails in connection with a second portion of references to the media content.

8. The system of claim 1, further comprising an update component that updates the thumbnail with the primary thumbnail in connection with a portion of references to the media content.

9. The system of claim 1, wherein the context is a language of the presentation of the media content.

10. The system of claim 1, wherein the context is a contextual location of the presentation of the media context.

11. The system of claim 1, wherein the context is an adult themed presentation of the media content.

12. A method, comprising:
selecting, by a system including a processor, multiple candidate thumbnails to be used in connection with a presentation of a reference to a video based upon a context of presentation of the video;
respectively determining, by the system, a performance of the multiple candidate thumbnails based on a performance metric resulting from a presentation of an associated candidate thumbnail in connection with the presentation of the reference to the video; and
selecting, by the system, from the multiple candidate thumbnails a primary thumbnail that is determined to yield a superior performance in connection with the performance metric.

13. The method of claim 12, wherein the selecting is based on input received in connection with an upload of the video to a video hosting site or service, analysis relating to thumbnail selection for the video, or trend data associated with thumbnail performance.

14. The method of claim 12, wherein the context is a language of the presentation of the video.

15. The method of claim 12, wherein the context is a contextual location of the presentation of the video.

16. The method of claim 12, wherein the context is an adult themed presentation of the media content.

17. A system, comprising:
means for determining a first candidate thumbnail and a second candidate thumbnail to be presented in connection with a reference to a media file based upon a context of presentation of the media file;
means for computing a first performance rating associated with the first candidate thumbnail and a second performance rating associated with the second candidate thumbnail; and
means for selecting one of the first candidate thumbnail or the second candidate thumbnail as a primary thumbnail based on a comparison of the first performance rating to the second performance rating.

18. The system of claim 17, further comprising means for facilitating presentation of the first candidate thumbnail in connection with a first set of references to the media file and the second candidate thumbnail in connection with a second set of references to the media file.

19. The system of claim 17, further comprising means for updating a thumbnail to be presented in connection with a reference to the media file with the primary thumbnail.

20. The system of claim 17, wherein the context is a language of the presentation of the video.
